(19) United States
(12) Patent Application Publication
(10) Pub. No.: US 2007/0202853 A1
(43) Pub. Date: Aug. 30, 2007

(54) Apparatus and method for connecting call in mobile communication terminal

(75) Inventor: Chang-Ho Soh, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/650,855

(22) Filed: Jan. 8, 2007

(30) Foreign Application Priority Data
Jan. 10, 2006 (KR) 10-2006-0002542

(51) Int. Cl. H04Q 7/38; H04M 3/42; H04Q 7/22

(52) U.S. Cl. 455/414.1

(57) ABSTRACT

Provided are an apparatus and method for connecting a call in a mobile communication terminal while observing calling time etiquette. When a user dials a phone number, the number is checked, and a local time of a call recipient of the number is calculated. A Checking whether the calculated local time is included in a preset etiquette time is performed. A message asking whether to proceed with the call when the calculated local time is included in the preset etiquette time is displayed to the user. The call is connected if the user elects to proceed with the call. When there is a time zone difference between the user and the call recipient, there is no need for the user to conduct a prior check. Thus, the possibility of the user inadvertently disturbing the call recipient at inappropriate hours during the night can be averted.

### PRIORITY

This application claims priority under 35 U.S.C. § 119 to an application entitled “Apparatus and Method for Connecting a Call in Mobile Communication Terminal” filed in the Korean Intellectual Property Office on Jan. 10, 2006 and allocated Serial No. 2006-2542, the contents of which are incorporated herein by reference.

### BACKGROUND OF THE INVENTION

1. Field of the Invention

The present invention relates generally to an apparatus and method for connecting a call in a mobile communication terminal, and more particularly, to an apparatus and method for alerting a user of the local time of a call recipient when a phone number corresponding to a certain time zone set in a time group is dialed and to confirm whether the user wishes to proceed with the call.

2. Description of the Related Art

The use of mobile communication terminals is rapidly increasing because they are easy to carry; service providers and terminal manufacturers are competitively developing mobile communication terminals with various special functions to attract potential users.

For example, mobile communication terminals have phone directories, games, schedulers, short messaging services (SMS), multimedia messaging service, broadcasting service, internet access and e-mailing, wake-up alarms, MPEG Audio Layer-3 (MP3), digital cameras, and various other functions.

Besides the functions already provided by mobile communication terminals, users require other practical functions for everyday use. One such function pertains to international calling. When a user wishes to make an international call, a function for letting the user know the local time of the intended call recipient is needed.

Most recently manufactured mobile communication terminals have a world time clock function that shows the current local time in any region of the world. However, the current technology requires a user to conduct a separate search for the local time of an intended overseas call recipient before dialing the recipient's number. This is therefore inconvenient for the user. When users fail to perform the step of checking the local time prior to making an international call, they often end up disturbing people in the middle of the night by calling.

### SUMMARY OF THE INVENTION

An object of the present invention is to substantially solve at least the above problems and/or disadvantages and to provide at least the advantages below. Accordingly, an object of the present invention is to provide an apparatus and method for connecting a call in a mobile communication terminal while observing recipient's calling time etiquette.

Another object of the present invention is to provide an apparatus and method for connecting a call in a mobile communication terminal that alert a user that a dialed number corresponds to a certain time zone falling into an etiquette time group, and allow the user to decide whether to proceed with the call.

A further object of the present invention is to provide an apparatus and method for connecting a call in a mobile communication terminal that allows a user to observe overseas calling etiquette by refraining from calling at inappropriate hours to avoid inconveniencing a call recipient when the user dials the recipient's number.

According to a first aspect of the present invention, there is provided a method for connecting a call in a mobile communication terminal while observing calling time etiquette, the method includes checking the phone number when dialed by a user, and calculating the local time of the called number; checking whether the calculated local time is included in a preset etiquette time; and displaying a message to the user asking whether to proceed with the call when the calculated local time is included in the preset time etiquette.

According to a second aspect of the present invention, there is provided an apparatus for connecting a call in a mobile communication terminal while observing calling time etiquette, the apparatus includes a controller for calculating the local time of a called recipient, checking whether the calculated local time corresponds to a preset etiquette time, and a display unit for so displaying.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of the configuration of a typical mobile communication terminal according to the present invention;

FIG. 2 is a flowchart of a process for setting etiquette time in a mobile communication terminal according to the present invention; and

FIG. 3 is a flowchart of a process for checking the local time of a call recipient and implementing an etiquette mode when an international number is dialed from a mobile communication terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Described hereinafter are an apparatus and method for connecting a call in a mobile communication terminal that alert a user that a dialed number belongs to a time zone falling within a set etiquette time, and allow the user to decide whether to proceed with the call.

In the below description, the mobile communication terminal refers to a cellular phone, a Personal Communication System (PCS) phone, a Personal Data Assistant (PDA), an International Mobile Telecommunication-2000 (IMT-2000) terminal, and other types of terminals. The below description will be made referring to terminals with the general configuration of the above-described terminals.

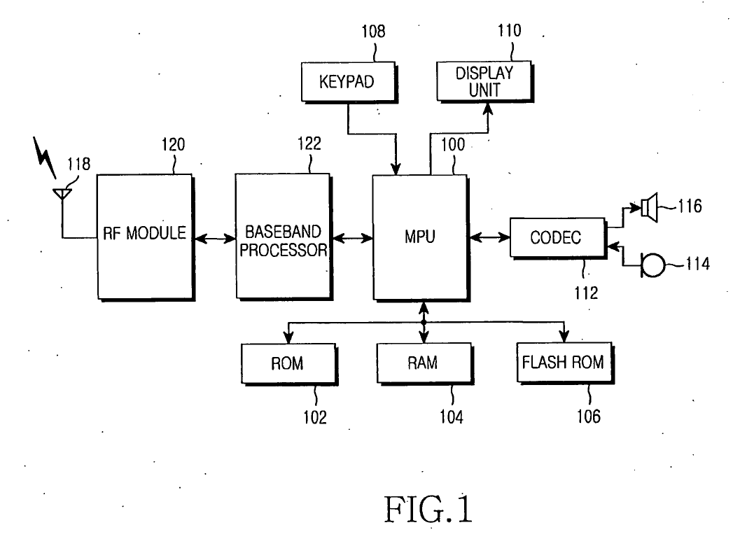

Referring to FIG. 1, a controller 100, or microprocessor unit (MPU), performs the overall operations of a mobile communication terminal. For instance, it performs processing and controlling of audio communication and data communication. It also has an added capability of alerting a user when a dialed number belongs to a time zone falling within a set etiquette time, and allows the user to decide whether to proceed with the call. Therefore, a description of the processing and controlling of the above-described controller 100 will now be given.

The Read Only Memory (ROM) 102 stores microcodes of programs for the controller's 100 processing and controlling, and various reference data. The ROM 102 especially stores programs for setting the etiquette time, verifying the current time of the region in which a call recipient lives, and providing an option to continue with a dialed call when the number coincides with the etiquette time. Random Access Memory (RAM) 104 is the working memory of the controller 100, for storing temporary data arising from the use of various programs. It especially stores the time zone of a call recipient in the present invention. A Flash ROM 106 is used to store phone directory data, sent messages, received messages, and other renewable pieces of storage data. In the present invention, it especially stores etiquette times, area codes by country and region, and time zones by country and region in order to verify the current local time of a call recipient. Also, the user may input a recipient's time zone.

The keypad 108 consists of a plurality of function keys/buttons including number keys for the numerals 0-9, a Menu key, a Cancel (delete) key, an OK key, a Talk key, an End key, an Internet Connection key, Navigational (or arrow) keys, and letter keys (for text messaging, etc., that share the other keys). When a user presses a key, its corresponding input signal is sent to the controller 100.

The display unit 110 displays operating information during the operation of the mobile communication terminal, numerals and characters that have been entered, various moving images and still images, etc. The display unit 110 may use a color Liquid Crystal Display (LCD). Also, the display unit 110 in the present invention displays a call recipient's current local time calculated by the controller 100.

The Coder-Decoder (CODEC) 112 is connected to the controller 100, and the microphone 114 and the speaker 116 are connected to the CODEC 112. The CODEC 112, the microphone 114, and the speaker 116 serve as an audio input/output block for voice communication and audio recording. The CODEC 112 converts PCM data provided from the controller 100 into analog audio signals to output the analog audio signals through the speaker 116, and converts audio signals received through the microphone 114 into PCM data to provide the PCM data to the controller 100.

The Radio Frequency (RF) module 120 down-converts an RF signal received through the antenna 118 to provide the down-converted signal to the baseband processor 122, and up-converts a baseband signal from the baseband processor 122 to transmit the up-converted signal through the antenna 118. The baseband processor 122 processes a baseband signal transmitted and received between the RF module 120 and the controller 100. For example, during a transmitting operation, the baseband processor 122 channel-codes and spreads data to be transmitted. During a reception operation, the baseband processor 122 despreads and channel-decodes a received signal.

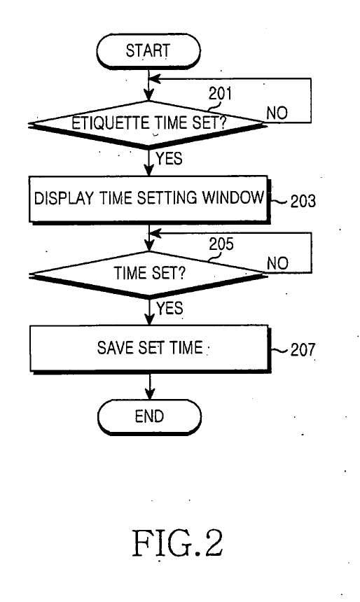

Referring to FIG. 2, the controller 100 detects in step 201 whether there has been a selection of an etiquette time setting menu. If an etiquette time setting menu has been selected, the controller 100 displays a time setting window for setting an etiquette time in step 203.

In step 205, the controller 100 checks for a specific input time or whether to use the etiquette time selected by a user.

When a time setting is made, the controller 100 determines whether the set time is set as the etiquette time and it is stored.

Thereafter, the controller 100 completes the process.

In the above description, the etiquette time may be divided into groups (for example, by country code, by group, by call recipient, and by domestic/international numbers) and set at different times for the different groups. For instance, groups that include children may be set at an etiquette time of 9:00 AM to 8:00 PM, and other groups may be set at an etiquette time of 11:00 PM to 7:00 PM.

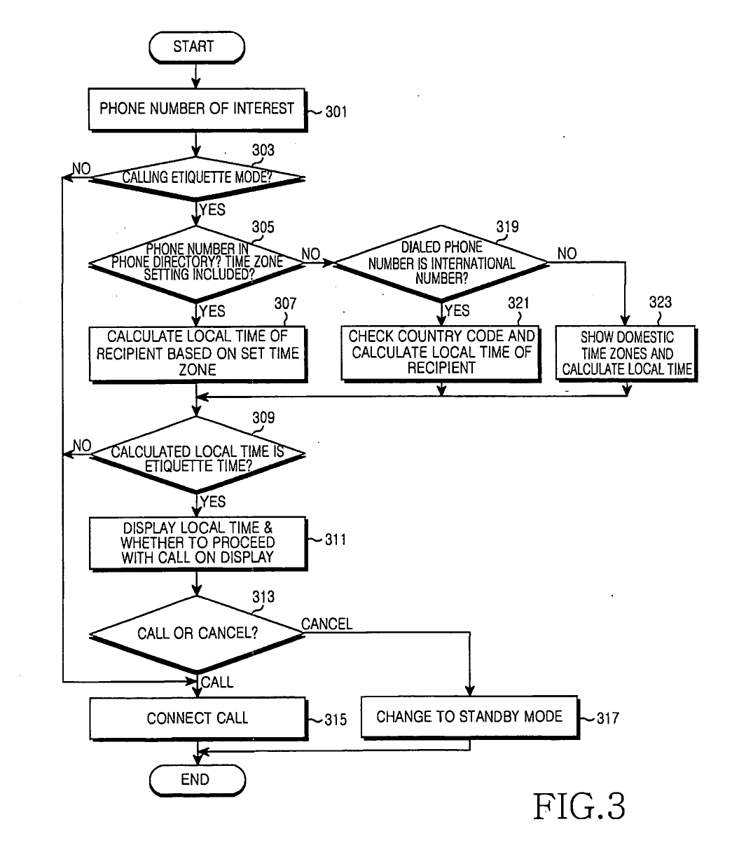

Referring to FIG. 3, when a user dials a phone number in step 301, the controller 100 checks in step 303 whether a call etiquette mode has been set.

If the call etiquette mode has not been set, the controller 100 would proceed directly to step 315 and would perform the dialing of the dialed number and complete its main algorithm.

If the call etiquette mode has been set, the controller 100 proceeds to step 305, in which it checks whether the dialed number is listed in the phone directory and whether the time zone of the phone number has been set in the phone directory.

If the dialed phone number is not listed in the phone directory, or if it is listed but doesn't have a time zone setting, the controller 100 performs step 319 to check if the number is an international number, or more specifically, if the dialed number is in the form of an international phone provider's prefix number+country code+phone number.

If the dialed phone number is an international number, the controller 100 performs step 321, in which it checks the country code of the dialed number and derives the time difference between the dialed country and the country the user is dialing from. For example, if the user dials the number “001-49-0000000” from the Republic of Korea at 10:00 AM, the controller 100 registers the country code “49” from the dialed number as that of Germany, and determines that since there is a 8 hour time difference between Germany and Korea, the local time in Germany (where the call receiver is) is 2:00 PM.

When the local time is derived, the controller 100 performs step 309, in which it is determined whether the derived time is included in the etiquette time.

In step 319, if the dialed number is not an international number, the controller 100 proceeds to step 323, in which the time zone(s) of that country is (are) used to determine the local time of the call recipient. In other words, in a country with more than one time zone, the local time of the call recipient is derived in anticipation of a discrepancy in time existing between the caller and the recipient. For example, the controller may refer to the area code within the dialed number or check the location of the mobile service provider of the recipient to determine the local time of the recipient, in order to prevent time discrepancies.

When the local time is derived, the controller 100 performs step 309 to determine whether the derived time is included in the etiquette time.

If it is determined in step 305 that the dialed number is contained in the phone directory and has a time zone setting, the controller 100 performs step 307, in which it derives the local time of the call recipient based on the set time zone. For example, at 8:00 PM, when the user dials a number with a “+3” hour time zone setting, the controller 100 determines the local time of the call receiver to be 3 hours later than that of the caller, or 11:00 PM.

In step 309, the controller 100 determines whether the derived local time falls within the etiquette time.

If the derived local time is not included in the etiquette time, the controller 100 actually calls the dialed (or input) number in step 315.

For example, if a number is dialed in a mobile communication terminal in which an etiquette time is set between 10:00 PM to 7:00 AM, if the derived local time of the dialed number is 7:00 PM, it is not included in the etiquette time, so the controller 100 dials the input number.

If the derived local number is included in the etiquette time, the controller 100 performs step 311, in which the user is notified of the derived local time and is asked whether she/he wishes to proceed with the call in a predetermined region of the display unit 110. In other words, the user is notified that the person she/he is about to call is in an area with a local time that is within the parameters of the etiquette time setting, and is asked whether to ignore the etiquette time and call that person anyway.

For example, if the etiquette time was set for between 10:00 PM and 7:00 AM, and a user dials a number on the mobile communication terminal, if the calculated local time is 11:00 PM, the user is informed that the current time of 11:00 PM falls within the etiquette time and is allowed to choose whether to proceed with the call or not through the display unit.

Here, when the user did not input time settings and dials a number within the country, a message alerts the user that there may be a time difference between the user and the recipient due to time zone difference (should the country lie within multiple time zones).

In step 313, the controller 100 determines whether the user has selected whether to proceed with or cancel the call. If the call is canceled, the controller performs step 317, in which the number is not dialed and the mobile communication terminal is put on standby, whereupon the controller 100 ends the main algorithm.

If the user opts to proceed with the call, the controller 100 actually dials the input number in step 315.

Afterwards, the controller 100 ends the process.

In the above description, the determination of whether to use the dialing etiquette mode may be made based on groups (for example, by country, by group, by call receivers, and by domestic/international numbers). For instance, the etiquette mode may be applied to a group of phone numbers outside the country, and the etiquette mode may be set not to apply to domestic phone numbers.

As described above, when the user of a mobile communication terminal of the present invention dials a certain number, when the local time of that number corresponds to a preset etiquette time, the user is asked whether she/he wishes to proceed with the call. Thus, when a local time difference between the user and the call recipient exists, there is no need on the part of the user to calculate the local time of the call recipient beforehand, averting the possibility of inadvertently disturbing someone at inappropriate hours during the night.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method for connecting a call in a mobile communication terminal while observing calling time etiquette, comprising the steps of:
checking a phone number when dialed, and calculating a local time of a call recipient of the dialed phone number;
checking whether the calculated local time is included in a preset etiquette time; and
displaying a message to the user asking whether to proceed with the call when the calculated local time is included in the preset etiquette time.

2. The method of claim 1, wherein the calculating of the local time comprises:
checking whether the dialed phone number includes time zone information set by the user; and
using the set time zone information as a basis for calculating the local time of the call recipient, when the dialed phone number includes time zone information set by the user.

3. The method of claim 2, wherein when the phone number does not include time zone information set by the user, the calculating of the local time further comprises:
determining whether the dialed phone number is a domestic or an international phone number;
checking a country code of the dialed phone number and a time zone of the country code, when the dialed phone number is an international phone number; and
calculating the local time of the call recipient based on the time zone of the country code.

4. The method of claim 3, further comprising calculating the local time of the call recipient based on a domestic time zone, when the predetermined phone number is a domestic phone number

5. The method of claim 1, wherein the etiquette time is set or changed by the user.

6. The method of claim 1, further comprising connecting the call using the dialed phone number when the calculated local time is not included in the preset etiquette time.

7. The method of claim 1, wherein the displaying of the message to the user asking whether to proceed with the call comprises alerting the user that the calculated local time is included in the preset etiquette time.

8. The method of claim 1, further comprising:
checking whether the user elects to proceed with the call when the message asking whether to proceed with the call is displayed; and
connecting the call using the dialed number when the user elects to proceed with the call.

9. The method of claim 8, further comprising suspending the call connection and assuming a standby mode, when the user elects not to proceed with the call.

10. An apparatus for connecting a call in a mobile communication terminal while observing calling time etiquette, the apparatus comprising:
a controller for calculating a local time of a call recipient of a phone number when dialed, and checking whether the calculated local time corresponds to a preset etiquette time; and
a display unit for displaying that the calculated local time corresponds to the preset etiquette time when the calculated local time corresponds to the preset etiquette time.

11. The apparatus of claim 10, wherein the calculating of the local time uses a time zone of the dialed phone number, preset by the user.

12. The apparatus of claim 10, wherein the calculating of the local time uses a time zone of a country code of the dialed phone number.

13. The apparatus of claim 10, wherein the display unit displays a screen asking the user whether to proceed with a call using the dialed number.

14. A method for connecting a call in a mobile communication terminal, comprising the steps of:
displaying a local time of a dialed phone number; and
identifying whether the local time is a preset etiquette time.

15. The method of claim 14, further comprising connecting the call using the dialed phone number when the local time is not the preset etiquette time.

16. A mobile communication terminal comprising:
a controller for outputting a local time of a dialed phone number, and identifying whether the local time corresponds to a preset etiquette time; and
a display unit for displaying the local time.

17. The mobile communication terminal of claim 16, wherein the controller further performs connecting the call using the dialed phone number when the local time is not the preset etiquette time.
